(19) United States
(12) Patent Application Publication
(10) Pub. No.: US 2014/0104148 A1
(43) Pub. Date: Apr. 17, 2014

(54) Liquid Crystal Display and the Driving Circuit Thereof

(71) Applicant: Jinjie Wang, Shenzhen City (CN)

(72) Inventor: Jinjie Wang, Shenzhen City (CN)

(73) Assignee: Shenzhen China Star Potoelectronics Technology Co., Ltd., Shenzhen (CN)

(21) Appl. No.: 13/695,020

(22) PCT Filed: Oct. 16, 2012
(86) PCT No.: PCT/CN12/83007

§ 371 Date: Oct. 27, 2012

(30) Foreign Application Priority Data
Oct. 11, 2012 (CN) 201210384386.1

(51) Int. Cl. G09G 5/00

(52) U.S. Cl. CPC G09G 5/00
USPC 345/92

(57) ABSTRACT

A liquid crystal display and the driving circuit of the liquid crystal display are disclosed. Each switch corresponds to one channel of scanning drivers and at least one column of the pixels. Inputs of each switch electrically connect with one channel of the scanning drivers. Each output of each switches electrically connect with one scanning line of at least one column respectively so as to input scanning signals from the scanning driver to sub-pixel electrodes connected with the corresponding scanning lines.

### BACKGROUND OF THE INVENTION

1. Field of the Invention

Embodiments of the present disclosure relate to display technology, and more particularly to a liquid crystal display and the driving circuit thereof.

2. Discussion of the Related Art

Liquid crystal devices include array substrates, color film substrates, and liquid crystal layers arranged between the array substrates and the color film substrates. The liquid crystal device includes a plurality of pixels. Each of the pixels includes pixel electrodes arranged on the array substrate and common electrodes arranged on the color film substrate. The pixel electrodes and the common electrodes compose liquid crystal capacitors.

FIG. 1 is a schematic view of one typical array substrate. The array substrate includes scanning lines 101 arranged in a column direction, data lines 103 arranged in a row direction, R pixel electrodes, G pixel electrodes and B pixel electrodes and thin transistors 105. The R pixel electrodes, G pixel electrodes and B pixel electrodes and thin transistors are arranged in a plurality of areas defined by the scanning lines 101 and the data lines 103. The R pixel electrodes, G pixel electrodes and B pixel electrodes are arranged along the data lines 103. Data drivers and scanning drivers (not shown) respectively connects with the data lines 103 and the scanning lines 101. Wherein gates of the thin transistors 105 of the same column electrically connect to the closest scanning line. Sources of the thin transistors 105 of the same row electrically connect to the closest data line. Each drain of the thin transistors 105 electrically connect to the pixel electrodes within one area.

The level of the pixel electrodes changes when the data lines receive data signals from the data drivers or when the scanning lines receive scanning signals from the scanning driver. As such, the alignment direction of the liquid crystals also changes so that the brightness of the pixels is controlled by configuring the light transmission rate.

However, at least 3M data lines and N scanning lines are needed for one typical liquid crystal display with M×N resolution. In addition, if the number of tunnels for the data drivers is a and the number of tunnels for the scanning drivers is b, the typical liquid crystal display needs 3m/a data drivers and n/b scanning drivers. As the cost of the data drivers is higher than that of the scanning drivers, the manufacturing cost would be high if the number of the data drivers is more than that of the scanning drivers.

As shown in FIG. 2, a general solution is to arrange the R pixel electrodes, G pixel electrodes, and B pixel electrodes along the scanning lines 102. In this way, m data lines 104 and 3n scanning lines 102 are needed, and only m/a data drivers and 3n/b scanning drivers are needed. Only two-third data drivers are needed, but the number of scanning drivers is triple, and thus the cost is not reduced.

### SUMMARY

The object of the claimed invention is to provide a liquid crystal display and the driving circuit thereof, wherein only a smaller amount of drivers is needed so that the cost is reduced.

In one aspect, a liquid crystal display includes a first substrate, a second substrate opposite to the first substrate, and a liquid crystal layer arranged between the first substrate and the second substrate, wherein the first substrate is an array substrate, and the second substrate is a color film substrate. The first substrate includes a plurality of pixels arranged in matrix, and a plurality of scanning drivers, a plurality of data drivers, a plurality of switches arranged in a rim of the matrix. Wherein each pixels includes data lines arranged in a row direction, at least three scanning line arranged in a column direction, pixel electrodes and a plurality of controlled switches, each pixel electrodes includes at least a R pixel electrode, a G pixel electrode, and a B pixel electrode arranged along the data line, and each of the R pixel electrode, the G pixel electrode, and the B pixel electrode at least corresponds to one scanning line and one controlled switch, controlled terminals of the controlled switches electrically connect with at least one scanning line, inputs of the controlled switches electrically connect with the data lines, outputs of the controlled switches electrically connect with the at least one of R sub-pixel electrodes, G sub-pixel electrodes, and B sub-pixel electrodes. The data lines of each of the sub-pixel electrodes connect with each other to form a conductive line, the three scanning lines of the pixels connect with each other to form a conductive line. Each switch corresponds to one channel of the scanning drivers and corresponds to at least one column of the pixels, each switches includes an input and at least three outputs, the input of the switch electrically connects with one channel of the scanning driver, each of the outputs of the switch electrically connect with the scanning lines respectively for selectively input the scanning signals from the channel to the sub-pixel electrodes of the column. The number of the outputs of the switch is the same with the number of the scanning lines of the pixels. The data drivers electrically connect with the data lines so as to input data signals to each of the sub-pixel electrodes.

Wherein: the controlled switch is a first thin film transistor; each pixels includes a first scanning line, a second scanning line, a third scanning line arranged in the row direction, a gate of the first thin film transistors corresponding to the R sub-pixel electrode electrically connects with the first scanning line, the gate of the first thin film transistors corresponding to the R sub-pixel electrode electrically connects with the second scanning line, the gate of the first thin film transistors corresponding to the R sub-pixel electrode electrically connects with the second scanning line; each switch corresponds to one column of pixels, each switch includes a first output a second output and a third output electrically connects with the first scanning line, the second scanning line, the third scanning line respectively so as to selectively input the scanning signals from the scanning driver to sub-pixel electrodes of one column; and wherein the switch inputs the scanning signals to the R sub-pixel electrode of the pixel of one column, and the data drivers inputs the data signals to the R sub-pixel electrode of the pixel of one column, the switch inputs the scanning signals to the G sub-pixel electrode of the pixel of one column, and the data drivers inputs the data signals to the G sub-pixel electrode of the pixel of one column, the switch inputs the scanning signals to the B sub-pixel electrode of the pixel of one column, and the data drivers inputs the data signals to the B sub-pixel electrode of the pixel of one column.

Wherein each switches includes: a first selection line, a second selection line, a third selection line, a fourth selection line, a fifth selection line, a sixth selection line, a low level signal line arranged in the row direction; a first driver for inputting level selection signals to the first selection line, the second selection line, the third selection line, the fourth selection line, the fifth selection line, the sixth selection line and for inputting inputs low level to the low level signal line; a first field effect transistor, the gate of the first field effect transistor electrically connects with the first selection line, a source of the first field effect transistor electrically connects with one channel of the scanning driver, and a drain of the first field effect transistor electrically connects with the first scanning line; a second field effect transistor, a gate of the second field effect transistor electrically connects with the second selection line, a source of the second field effect transistor electrically connects with one channel of the scanning driver, a drain of the second field effect transistor electrically connects with the second scanning line; a third field effect transistor, a gate of the third field effect transistor electrically connects with the third selection line, a source of the third field effect transistor electrically connects with one channel of the scanning driver, and a drain of the third field effect transistor electrically connects with the third scanning line; a fourth field effect transistor, a gate of the fourth field effect transistor electrically connects with the fourth selection line, a source of the fourth field effect transistor electrically connects with the low level signals lines, a drain of the fourth field effect transistor electrically connects with the first scanning line; a fifth field effect transistor, a gate of the fifth field effect transistor electrically connects with the fifth selection line, a source of the fifth field effect transistor electrically connects with the low level signal line, a drain of the fifth field effect transistor electrically connects with the second scanning line; a sixth field effect transistor, a gate of the sixth field effect transistor electrically connects with the sixth selection line, a source of the sixth field effect transistor electrically connects with the low level signal line, a drain of the sixth field effect transistor electrically connects with the third scanning line; when the first driver inputs high level to the first selection line, the fifth selection line and the sixth selection line, the first field effect transistor, the fifth field effect transistor, and the sixth field effect transistor are closed, and when the first driver inputs low level to the second selection line, the third selection line, the fourth selection line and the low level signal line, the second field effect transistor, the third field effect transistor and the fourth field effect transistor are open, the scanning signals from the scanning driver are transmitted to the first scanning line via the first field effect transistor, the low level from the low level signal line is transmitted to the second scanning line via the fifth field effect transistor and is transmitted to the third scanning line via the sixth field effect transistor so as to input the scanning signals to the R sub-pixel electrodes; when the first driver inputs high level to the second selection line, the fourth selection line and the sixth selection line, the second field effect transistor, the fourth field effect transistor and the sixth field effect transistor are closed, and when the first driver inputs the low level to the first selection line, the third selection line and the filth selection line, the low level signal line, the first field effect transistor, the third field effect transistor and the fifth field effect transistor are open, the scanning signals from the scanning driver are transmitted to the second scanning line via the second field effect transistor, the low level from the low level signal line is transmitted to the first scanning line via the fourth field effect transistor and is transmitted to the third scanning line via the sixth field effect transistor so as to input the scanning signals to the G sub-pixel electrodes and when the first driver inputs the high level to the third selection line, the fourth selection line and the fifth selection line, the third field effect transistor, the fourth field effect transistor, and the filth field effect transistor are closed, and when the first driver inputs the low level to the first selection line, the second selection line, the sixth selection line, and the low level signal line, the first field effect transistor, the second field effect transistor, and the sixth field effect transistor are open, the scanning signals from the scanning driver are transmitted to the third scanning line via the third field effect transistor, the low level from the low level signal line is transmitted to the first scanning line via the fourth field effect transistor and is transmitted to the second scanning line via the fifth field effect transistor so as to input the scanning signals to the B sub-pixel electrodes.

In another aspect, a liquid crystal display includes a first substrate, a second substrate opposite to the first substrate, and a liquid crystal layer arranged between the first substrate and the second substrate, wherein the first substrate is an array substrate, and the second substrate is a color film substrate. The first substrate includes a plurality of pixels arranged in matrix, and a plurality of scanning drivers, a plurality of data drivers, a plurality of switches arranged in a rim of the matrix. Wherein each pixels includes data lines arranged in a row direction, at least three scanning line arranged in a column direction, pixel electrodes and a plurality of controlled switches, each pixel electrodes includes at least a R pixel electrode, a G pixel electrode, and a B pixel electrode arranged along the data line, and each of the R pixel electrode, the G pixel electrode, and the B pixel electrode at least corresponds to one scanning line and one controlled switch, controlled terminals of the controlled switches electrically connect with at least one scanning line, inputs of the controlled switches electrically connect with the data lines, outputs of the controlled switches electrically connect with the at least one of R sub-pixel electrodes, G sub-pixel electrodes, and B sub-pixel electrodes; each switch corresponds to one channel of the scanning drivers and corresponds to at least one column of the pixels, each switches includes an input and at least three outputs, the input of the switch electrically connects with one channel of the scanning driver, each of the outputs of the switch electrically connect with the scanning lines respectively for selectively input the scanning signals from the channel to the sub-pixel electrodes of the column; and the data drivers electrically connect with the data lines so as to input data signals to each of the sub-pixel electrodes.

Wherein: the controlled switch is a first thin film transistor; each pixels includes a first scanning line, a second scanning line, a third scanning line arranged in the row direction, a gate of the first thin film transistors corresponding to the R sub-pixel electrode electrically connects with the first scanning line, the gate of the first thin film transistors corresponding to the R sub-pixel electrode electrically connects with the second scanning line, the gate of the first thin film transistors corresponding to the R sub-pixel electrode electrically connects with the second scanning line; each switch corresponds to one column of pixels, each switch includes a first output, a second output and a third output electrically connects with the first scanning line, the second scanning line, the third scanning line respectively so as to selectively input the scanning signals from the scanning driver to sub-pixel electrodes of one column; and wherein the switch inputs the scanning signals to the R sub-pixel electrode of the pixel of one column, and the data drivers inputs the data signals to the R sub-pixel electrode of the pixel of one column, the switch inputs the scanning signals to the Gi sub-pixel electrode of the pixel of one column, and the data drivers inputs the data signals to the G sub-pixel electrode of the pixel of one column, the switch inputs the scanning signals to the B sub-pixel electrode of the pixel of one column, and the data drivers inputs the data signals to the B sub-pixel electrode of the pixel of one column.

Wherein each switches includes: a first selection line, a second selection line, a third selection line, a fourth selection line, a fifth selection line, a sixth selection line, a low level signal line arranged in the row direction; a first driver for inputting level selection signals to the first selection line, the second selection line, the third selection line, the fourth selection line, the fifth selection line, the sixth selection line and for inputting inputs low level to the low level signal line; a first field effect transistor, the gate of the first field effect transistor electrically connects with the first selection line, a source of the first field effect transistor electrically connects with one channel of the scanning driver, and a drain of the first field effect transistor electrically connects with the first scanning line; a second field effect transistor, a gate of the second field effect transistor electrically connects with the second selection line, a source of the second field effect transistor electrically connects with one channel of the scanning driver, a drain of the second field effect transistor electrically connects with the second scanning line; a third field effect transistor, a gate of the third field effect transistor electrically connects with the third selection line, a source of the third field effect transistor electrically connects with one channel of the scanning driver, and a drain of the third field effect transistor electrically connects with the third scanning line; a fourth field effect transistor, a gate of the fourth field effect transistor electrically connects with the fourth selection line, a source of the fourth field effect transistor electrically connects with the low level signals lines, a drain of the fourth field effect transistor electrically connects with the first scanning line; a fifth field effect transistor, a gate of the fifth field effect transistor electrically connects with the fifth selection line, a source of the fifth field effect transistor electrically connects with the low level signal line, a drain of the fifth field effect transistor electrically connects with the second scanning line; a sixth field effect transistor, a gate of the sixth field effect transistor electrically connects with the sixth selection line, a source of the sixth field effect transistor electrically connects with the low level signal line, a drain of the sixth field effect transistor electrically connects with the third scanning line; when the first driver inputs high level to the first selection line, the fifth selection line and the sixth selection line, the first field effect transistor, the fifth field effect transistor, and the sixth field effect transistor are closed, and when the first driver inputs low level to the second selection line, the third selection line, the fourth selection line and the low level signal line, the second field effect transistor, the third field effect transistor and the fourth field effect transistor are open, the scanning signals from the scanning driver are transmitted to the first scanning line via the first field effect transistor, the low level from the low level signal line is transmitted to the second scanning line via the fifth field effect transistor and is transmitted to the third scanning line via the sixth field effect transistor so as to input the scanning signals to the R sub-pixel electrodes; when the first driver inputs high level to the second selection line, the fourth selection line and the sixth selection line, the second field effect transistor, the fourth field effect transistor and the sixth field effect transistor are closed, and when the first driver inputs the low level to the first selection line, the third selection line and the fifth selection line, the low level signal line, the first field effect transistor, the third field effect transistor and the fifth field effect transistor are open, the scanning signals from the scanning driver are transmitted to the second scanning line via the second field effect transistor, the low level from the low level signal line is transmitted to the first scanning line via the fourth field effect transistor and is transmitted to the third scanning line via the sixth field effect transistor so as to input the scanning signals to the G sub-pixel electrodes; and when the first driver inputs the high level to the third selection line, the fourth selection line and the fifth selection line, the third field effect transistor the fourth field effect transistor, and the fifth field effect transistor are closed, and when the first driver inputs the low level to the first selection line, the second selection line, the sixth selection line, and the low level signal line, the first field effect transistor, the second field effect transistor, and the sixth field effect transistor are open, the scanning signals from the scanning driver are transmitted to the third scanning line via the third field effect transistor, the low level from the low level signal line is transmitted to the first scanning line via the fourth field effect transistor and is transmitted to the second scanning line via the fifth field effect transistor so as to input the scanning signals to the B sub-pixel electrodes.

In another aspect, a liquid crystal display includes a plurality of scanning drivers, a plurality of data drivers, a plurality of switches arranged in a rim of the matrix of pixels. Wherein each pixels includes data lines arranged in a row direction, at least three scanning line arranged in a column direction, pixel electrodes and a plurality of controlled switches, each pixel electrodes includes at least a R pixel electrode, a G pixel electrode, and a B pixel electrode arranged along the data line, and each of the R pixel electrode, the G pixel electrode, and the B pixel electrode at least corresponds to one scanning line and one controlled switch, controlled terminals of the controlled switches electrically connect with at least one scanning line, inputs of the controlled switches electrically connect with the data lines, outputs of the controlled switches electrically connect with the at least one of R sub-pixel electrodes, G sub-pixel electrodes, and B sub-pixel electrodes; each switch corresponds to one channel of the scanning drivers and corresponds to at least one column of the pixels, each switches includes an input and at least three outputs, the input of the switch electrically connects with one channel of the scanning driver, each of the outputs of the switch electrically connect with the scanning lines respectively for selectively input the scanning signals from the channel to the sub-pixel electrodes of the column; and the data drivers electrically connect with the data lines so as to input data signals to each of the sub-pixel electrodes.

Wherein: the controlled switch is a first thin film transistor; each pixels includes a first scanning line, a second scanning line, a third scanning line arranged in the row direction, a gate of the first thin film transistors corresponding to the R sub-pixel electrode electrically connects with the first scanning line, the gate of the first thin film transistors corresponding to the R sub-pixel electrode electrically connects with the second scanning line, the gate of the first thin film transistors corresponding to the R sub-pixel electrode electrically connects with the second scanning line; each switch corresponds to one column of pixels, each switch includes a first output, a second output and a third output electrically connects with the first scanning line, the second scanning line, the third scanning line respectively so as to selectively input the scanning signals from the scanning driver to sub-pixel electrodes of one column; and wherein the switch inputs the scanning signals to the R sub-pixel electrode of the pixel of one column, and the data drivers inputs the data signals to the R sub-pixel electrode of the pixel of one column, the switch inputs the scanning signals to the G sub-pixel electrode of the pixel of one column, and the data drivers inputs the data signals to the G sub-pixel electrode of the pixel of one column, the switch inputs the scanning signals to the B sub-pixel electrode of the pixel of one column, and the data drivers inputs the data signals to the B sub-pixel electrode of the pixel of one column.

Wherein each switches includes: a first selection line, a second selection line, a third selection line, a fourth selection line, a fifth selection line, a sixth selection line, a low level signal line arranged in the row direction; a first driver for inputting level selection signals to the first selection line, the second selection line, the third selection line, the fourth selection line, the fifth selection line, the sixth selection line and for inputting inputs low level to the low level signal line; a first field effect transistor, the gate of the first field effect transistor electrically connects with the first selection line, a source of the first field effect transistor electrically connects with one channel of the scanning driver, and a drain of the first field effect transistor electrically connects with the first scanning line; a second field effect transistor, a gate of the second field effect transistor electrically connects with the second selection line, a source of the second field effect transistor electrically connects with one channel of the scanning driver, a drain of the second field effect transistor electrically connects with the second scanning line; a third field effect transistor, a gate of the third field effect transistor electrically connects with the third selection line, a source of the third field effect transistor electrically connects with one channel of the scanning driver, and a drain of the third field effect transistor electrically connects with the third scanning line; a fourth field effect transistor, a gate of the fourth field effect transistor electrically connects with the fourth selection line, a source of the fourth field effect transistor electrically connects with the low level signals lines, a drain of the fourth field effect transistor electrically connects with the first scanning line; a fifth field effect transistor, a gate of the fifth field effect transistor electrically connects with the fifth selection line, a source of the fifth field effect transistor electrically connects with the low level signal line, a drain of the fifth field effect transistor electrically connects with the second scanning line; a sixth field effect transistor, a gate of the sixth field effect transistor electrically connects with the sixth selection line, a source of the sixth field effect transistor electrically connects with the low level signal line, a drain of the sixth field effect transistor electrically connects with the third scanning line; when the first driver inputs high level to the first selection line, the fifth selection line and the sixth selection line, the first field effect transistor, the fifth field effect transistor, and the sixth field effect transistor are closed, and when the first driver inputs low level to the second selection line, the third selection line, the fourth selection line and the low level signal line, the second field effect transistor, the third field effect transistor and the fourth field effect transistor are open, the scanning signals from the scanning driver are transmitted to the first scanning line via the first field effect transistor, the low level from the low level signal line is transmitted to the second scanning line via the fifth field effect transistor and is transmitted to the third scanning line via the sixth field effect transistor so as to input the scanning signals to the R sub-pixel electrodes; when the first driver inputs high level to the second selection line, the fourth selection line and the sixth selection line, the second field effect transistor, the fourth field effect transistor and the sixth field effect transistor are closed, and when the first driver inputs the low level to the first selection line, the third selection line and the fifth selection line, the low level signal line, the first field effect transistor, the third field effect transistor and the fifth field effect transistor are open, the scanning signals from the scanning driver are transmitted to the second scanning line via the second field effect transistor, the low level from the low level signal line is transmitted to the first scanning line via the fourth field effect transistor and is transmitted to the third scanning line via the sixth field effect transistor so as to input the scanning signals to the G sub-pixel electrodes; and when the first driver inputs the high level to the third selection line, the fourth selection line and the fifth selection line, the third field effect transistor, the fourth field effect transistor, and the fifth field effect transistor are closed, and when the first driver inputs the low level to the first selection line, the second selection line, the sixth selection line, and the low level signal line, the first field effect transistor, the second field effect transistor, and the sixth field effect transistor are open, the scanning signals from the scanning driver are transmitted to the third scanning line via the third field effect transistor, the low level from the low level signal line is transmitted to the first scanning line via the fourth field effect transistor and is transmitted to the second scanning line via the fifth field effect transistor so as to input the scanning signals to the B sub-pixel electrodes.

By adopting the switches capable of driving three sub-pixel electrodes corresponding to three scanning lines, the number of the scanning drivers may be reduced. As a result, the cost is also reduced.

### BRIEF DESCRIPTION OF THE DRAWINGS

FIG. 1 is a schematic view of one typical array substrate.

FIG. 2 is a schematic view of another typical array substrate.

FIG. 3 is a front view of the liquid crystal display in accordance with a first embodiment.

FIG. 4 is a side view of the liquid crystal display of FIG. 3

FIG. 5 is a circuit diagram of the driving circuit on the first substrate of FIG. 3 in accordance with the first embodiment.

FIG. 6 is a detail circuit diagram of the driving circuit of FIG. 5.

FIG. 7 is a circuit diagram of the driving circuit on the first substrate of FIG. 3 in accordance with the second embodiment.

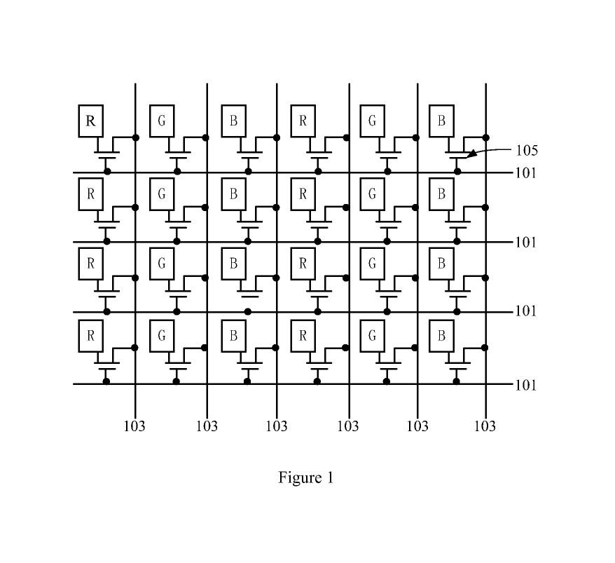

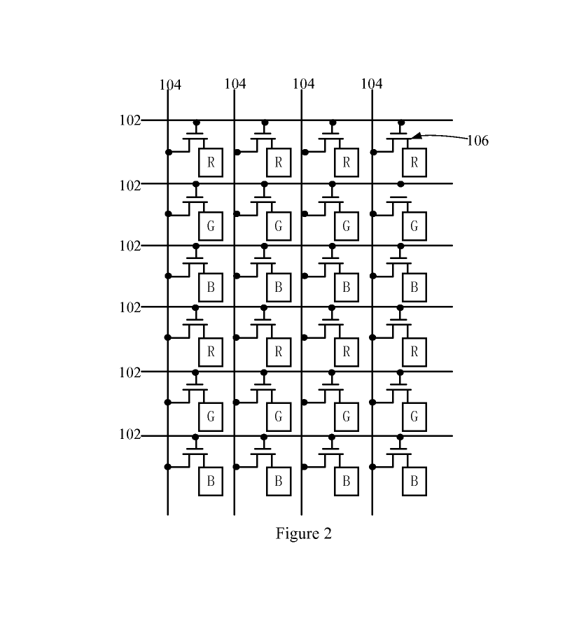

### DETAILED DESCRIPTION OF THE EMBODIMENTS

Embodiments of the invention will now be described more fully hereinafter with reference to the accompanying drawings, in which embodiments of the invention are shown.

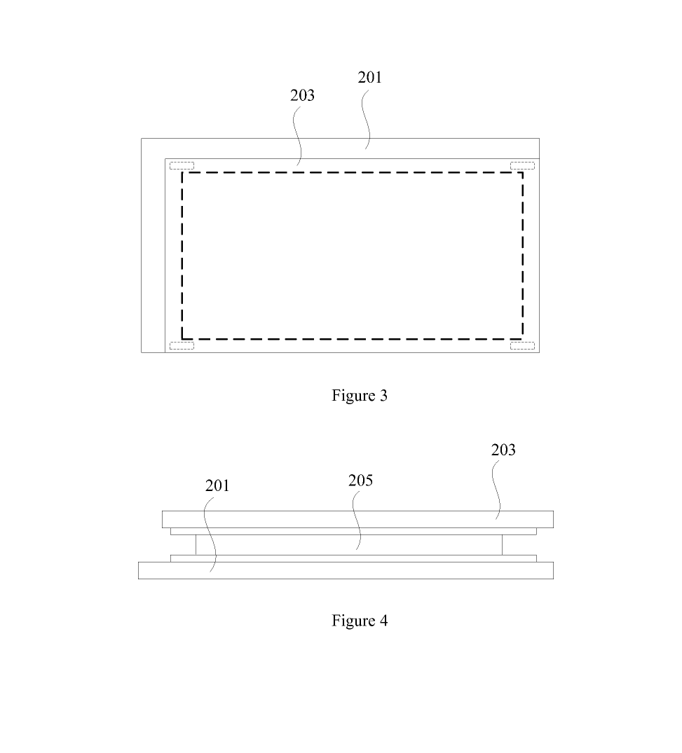

FIG. 3 is a front view of the liquid crystal display in accordance with a first embodiment. FIG. 4 is a side view of the liquid crystal display of FIG. 3. The liquid crystal display includes a first substrate 201, a second substrate 203 opposite to the first substrate 201, and a liquid crystal layer 205 arranged between the first substrate 201 and the second substrate 203. The first substrate 201 is an array substrate, and the second substrate 203 is a color film substrate.

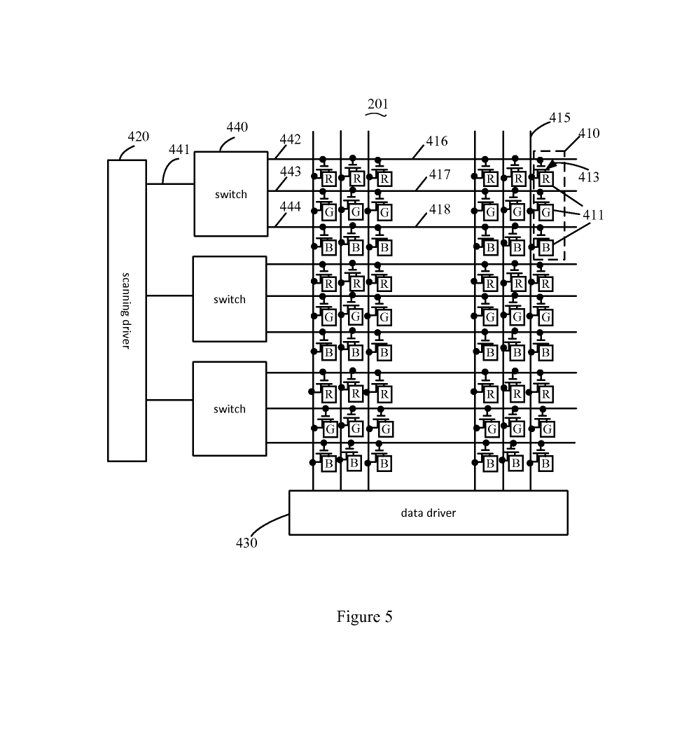

FIG. 5 is a circuit diagram of the driving circuit on the first substrate of FIG. 3 in accordance with the first embodiment. In the embodiment, the first substrate 201 includes a plurality of pixels 410 arranged in matrix, and a plurality of scanning drivers 420, a plurality of data drivers 430, a plurality of switches 440 arranged in a rim of the matrix.

Each pixels 410 includes data line 415 arranged in a row direction, a first scanning line 416, a second scanning line 417, a third scanning line 418, pixel electrodes 411 and a plurality of first thin film transistors 413. The first scanning line 416, the second scanning line 417, the third scanning line 418 are arranged in a column direction. One pixel electrode 411 include one R pixel electrode, one G pixel electrode, and one B pixel electrode arranged along the data line 415, and each of the R pixel electrode, the G pixel electrode, and the B pixel electrode corresponds to one first thin film transistors 413, and respectively corresponds to the first scanning line 416, the second scanning line 417, and the third scanning line 418. It is to be noted that the data line 415, the first scanning line 416, the second scanning line 417, and the third scanning line 418 connect with each other.

The R pixel electrodes connect with the data line 415 and the first scanning line 416. The G pixel electrodes connect with the data line 415 and the second scanning line 417. The B pixel electrodes connect with the data line 415 and the third scanning line 418.

For each of the pixels 410, the R sub-pixel electrode electrically connects with the drain of the corresponding first thin film transistors 413. In addition, the gate of the first thin film transistors 413 electrically connects with the first scanning line 416, and the source of the first thin film transistors 413 connects with the data line 415.

For each of the pixels 410, the G sub-pixel electrode electrically connects with the drain of the corresponding first thin film transistors 413. In addition, the gate of the first thin film transistors 413 electrically connects with the second scanning line 417, and the source of the first thin film transistors 413 connects with the data line 415.

For each of the pixels 410, the B sub-pixel electrode electrically connects with the drain of the corresponding first thin film transistors 413. In addition, the gate of the first thin film transistors 413 electrically connects with the third scanning line 418, and the source of the first thin film transistors 413 connects with the data line 415.

Each switch 440 corresponds to one channel of the scanning drivers 420 and one column of the pixels 410 for selectively inputting scanning signals from the channel to the sub-pixel electrode of pixels 410 of one column. The switch 440 includes an input 441, a first output 442, a second output 443, and a third output 444. The input 441 electrically connects with one channel of the scanning drivers 420. The first output 442, the second output 443, the third output 444 respectively connects with the first scanning line 416, the second scanning line 417, the third scanning line 418 of pixels 410 of one column.

In addition, multiple switches 440 correspond to one scanning driver 420. The data drivers 430 electrically connect with the data lines 415 so as to input data signals to each of the sub-pixel electrodes.

It is to be noted that FIG. 5 only shows one scanning driver 420 and one data driver 430. However, the number of the scanning drivers 420 and the data drivers 430 may be adjusted according to real scenarios.

It is to be understood that the first thin film transistors 413 may be replaced by triodes, Darlington transistors or switches.

The three sub-pixel electrodes of one pixel, which respectively corresponds to three scanning lines, may be driven by the switches 440 in a time-sharing way. As such, the multiple scanning lines may share the same channel of the scanning driver so that the number of the scanning drivers may be reduced.

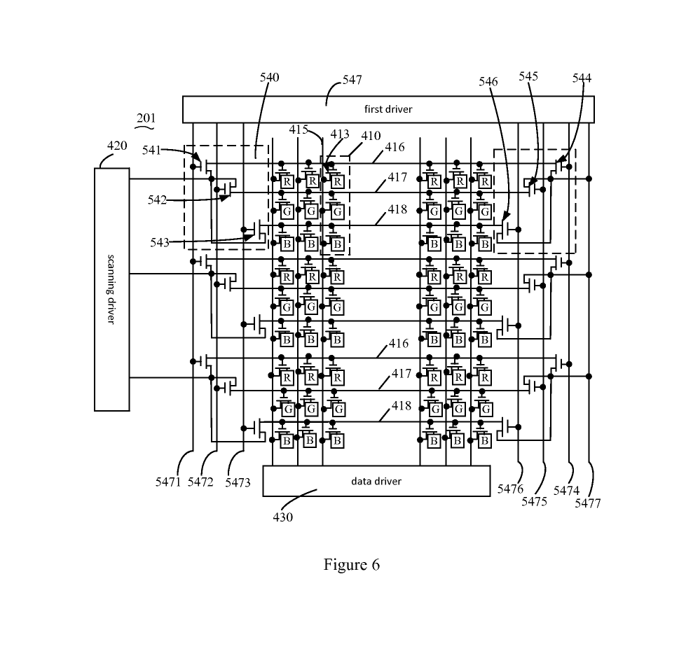

FIG. 6 is a detail circuit diagram of the driving circuit of FIG. 5. Each switches 540 includes a first selection line 5471, a second selection line 5472, a third selection line 5473, a fourth selection line 5474, a filth selection line 5475, a sixth selection line 5476, a low level signal line 5477, a first driver 547, a first field effect transistor 541, a second field effect transistor 542, a third field effect transistor 543, a fourth field effect transistor 544, a fifth field effect transistor 545, and a sixth field effect transistor 546.

The first selection line 5471, the second selection line 5472, the third selection line 5473, the fourth selection line 5474, the fifth selection line 5475, the sixth selection line 5476, the low level signal line 5477 are arranged on the first substrate 201 in the row direction.

The first driver 547 respectively connects with the first selection line 5471, the second selection line 5472, the third selection line 5473, the fourth selection line 5474, the fifth selection line 5475, the sixth selection line 5476, and the low level signal line 5477. The first driver 547 inputs level selection signals to the first selection line 5471, the second selection line 5472, the third selection line 5473, the fourth selection line 5474, the filth selection line 5475, and the sixth selection line 5476. In addition, the first driver inputs low level to the low level signal line 5477.

The gate of the first field effect transistor 541 electrically connects with the first selection line 5471. The source of the first field effect transistor 541 electrically connects with one channel of the scanning driver 420. The drain of the first field effect transistor 541 electrically connects with the first scanning line 416.

The gate of the second field effect transistor 542 electrically connects with the second selection line 5472. The source of the second field effect transistor 542 electrically connects with one channel of the scanning driver 420. The drain of the second field effect transistor 541 electrically connects with the second scanning line 417.

The gate of the third field effect transistor 543 electrically connects with the third selection line 5473. The source of the third field effect transistor 543 electrically connects with one channel of the scanning driver 420. The drain of the third field effect transistor 543 electrically connects with the third scanning line 418.

The gate of the fourth field effect transistor 544 electrically connects with the fourth selection line 5474. The source of the fourth field effect transistor 544 electrically connects with the low level signals lines 5477. The drain of the fourth field effect transistor 544 electrically connects with the first scanning line 416.

The gate of the fifth field effect transistor 545 electrically connects with the fifth selection line 5475. The source of the fifth field effect transistor 545 electrically connects with the low level signal line 5477. The drain of the fifth field effect transistor 545 electrically connects with the second scanning line 417.

The gate of the sixth field effect transistor 546 electrically connects with the sixth selection line 5476. The source of the sixth field effect transistor 546 electrically connects with the low level signal line 5477. The drain of the sixth field effect transistor 546 electrically connects with the third scanning line 418.

The data drivers 430 electrically connect with the data line 415 so as to input the data signals to the R sub-pixel electrodes, G sub-pixel electrodes, and B sub-pixel electrodes.

The driving circuit and the driving method will now be described with reference to FIG. 5 as an example. The switch 440 inputs the scanning signals to the R sub-pixel electrode of the pixel 410 of one column, and the data drivers 430 inputs the data signals to the R sub-pixel electrode of the pixel 410 of one column at the same time. The switch 440 inputs the scanning signals to the G sub-pixel electrode of the pixel 410 of one column, and the data drivers 430 inputs the data signals to the G sub-pixel electrode of the pixel 410 of one column at the same time. The switch 440 inputs the scanning signals to the B sub-pixel electrode of the pixel 410 of one column, and the data drivers 430 inputs the data signals to the B sub-pixel electrode of the pixel 410 of one column at the same time. The above process is repeated until the last sub-pixel electrodes of the last column are scanned.

Referring to FIG. 6, when the first driver 547 inputs high level to the first selection line 5471, the fifth selection line 5475 and the sixth selection line 5476, the first field effect transistor 541, the fifth field effect transistor 545, and the sixth field effect transistor 546 are closed. In addition, when the first driver 547 inputs low level to the second selection line 5472, the third selection line 5473, the fourth selection line 5474 and the low level signal line 5477, the second field effect transistor 542, the third field effect transistor 543 and the fourth field effect transistor 544 are open. As such, the scanning signals from the scanning driver 420 are transmitted to the first scanning line 416 via the first field effect transistor 541. The low level from the low level signal line 5477 is transmitted to the second scanning line 417 via the fifth field effect transistor 545 and is transmitted to the third scanning line 418 via the sixth field effect transistor 546. Thus, the scanning signals are provided to the R sub-pixel electrodes. Afterward, the data drivers 430 input the scanning signals to the R sub-pixel electrodes via the data line 415 so as to drive the R sub-pixel electrodes.

When the first driver 547 inputs high level to the second selection line 5472, the fourth selection line 5474 and the sixth selection line 5476, the second field effect transistor 542, the fourth field effect transistor 544 and the sixth field effect transistor 546 are closed. In addition, when the first driver 547 inputs the low level to the first selection line 5471, the third selection line 5473 and the fifth selection line 5475, the low level signal line 5477, the first field effect transistor 541, the third field effect transistor 543 and the fifth field effect transistor 545 are open. As such, the scanning signals from the scanning driver 420 are transmitted to the second scanning line 417 via the second field effect transistor 542. The low level from the low level signal line 5477 is transmitted to the first scanning line 416 via the fourth field effect transistor 544 and is transmitted to the third scanning line 418 via the sixth field effect transistor 546. Thus, the scanning signals are provided to the G sub-pixel electrodes. Afterward, the data drivers 430 input data signals to the G sub-pixel electrodes via the data line 415 so as to drive the G sub-pixel electrodes.

When the first driver 547 inputs the high level to the third selection line 5473, the fourth selection line 5474 and the fifth selection line 5475, the third field effect transistor 543, the fourth field effect transistor 544, and the fifth field effect transistor 545 are closed. In addition, when the first driver 547 inputs the low level to the first selection line 5471, the second selection line 5472, the sixth selection line 5476, and the low level signal line 5477, the first field effect transistor 541, the second field effect transistor 542, and the sixth field effect transistor 546 are open. As such, the scanning signals from the scanning driver 420 are transmitted to the third scanning line 418 via the third field effect transistor 543. The low level from the low level signal line 5477 is transmitted to the first scanning line 416 via the fourth field effect transistor 544 and is transmitted to the second scanning line 417 via the fifth field effect transistor 545. Thus, the scanning signals are provided to the B sub-pixel electrodes. Afterward, the data drivers 430 input data signals to the B sub-pixel electrodes via the data line 415 so as to drive the B sub-pixel electrodes.

In view of the above, the switch 440 inputs the scanning signals to one of the R sub-pixel electrode of one pixel of one column, and then the data driver 430 inputs the data signals to all of the R sub-pixel electrodes of the same column. Afterward, the switch 440 inputs the scanning signals to the G sub-pixel electrodes of the pixels of the same column, and then the data drivers 430 inputs the data signals to all of the G sub-pixel electrodes of the same column. Then the switch 440 inputs the scanning signals to the B sub-pixel electrodes of the pixels of the same column, and then the data drivers 430 inputs the data signals to all of the B sub-pixel electrodes of the same column. The process repeated until all of the frames are scanned.

It is to be understood that the driving method is similar when one switch 440 corresponds to pixels belongs to a plurality of columns.

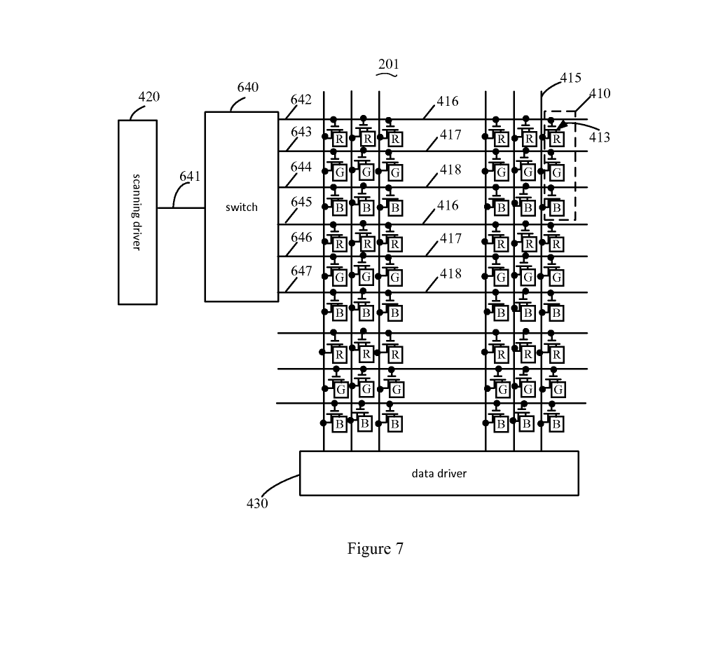

FIG. 7 is a circuit diagram of the driving circuit on the first substrate of FIG. 3 in accordance with the second embodiment. Each switch 640 corresponds to pixels of a first column and a second column, and the first column and the second column are adjacent to the switch 640. Each switch 640 includes an input 641, a first output 642, a second output 643, a third output 644, a fourth output 645, a fifth output 646 and a sixth output 647. The input 641 of the switch 640 electrically connect with the one channel of the scanning drivers 420. The first output 642 of the switch 640 electrically connects with the first scanning line 416 of the pixel of the first column. The second output 643 of the switch 640 electrically connects with the second scanning line 417 of the pixels of the first column. The third output 644 of the switch 640 electrically connects with the third scanning line 418 of the pixels of the first column. The fourth output 645 of the switch 640 electrically connects with the first scanning line 416 of the pixels of the second column. The fifth output 646 of the switch 640 electrically connects with the second scanning line 417 of the pixels of the second column. The sixth output 647 of the switch 640 electrically connects with the third scanning line 418 of the pixels of the second column. The above configuration is for selectively input the scanning signals from the scanning drivers 420 to one sub-pixel electrodes of the pixels of the first column or the second column.

It is to be understood that the switch 640 may correspond to pixels of a plurality of columns. Correspondingly, the number of the outputs of the switch 640 is the same with the number of the scanning lines of the pixels. In this way, the number of the channels of the scanning drivers may be reduced.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A liquid crystal display, comprising:
a first substrate;
a second substrate opposite to the first substrate;
a liquid crystal layer arranged between the first substrate and the second substrate, wherein the first substrate is an array substrate, and the second substrate is a color film substrate;
the first substrate comprises a plurality of pixels arranged in matrix, and a plurality of scanning drivers, a plurality of data drivers, a plurality of switches arranged in a rim of the matrix;
wherein each pixels comprises data lines arranged in a row direction, at least three scanning line arranged in a column direction, pixel electrodes and a plurality of controlled switches, each pixel electrodes comprises at least a R pixel electrode, a G pixel electrode, and a B pixel electrode arranged along the data line, and each of the R pixel electrode, the G pixel electrode, and the B pixel electrode at least corresponds to one scanning line and one controlled switch, controlled terminals of the controlled switches electrically connect with at least one scanning line, inputs of the controlled switches electrically connect with the data lines, outputs of the controlled switches electrically connect with the at least one of R sub-pixel electrodes, G sub-pixel electrodes, and B sub-pixel electrodes;
the data lines of each of the sub-pixel electrodes connect with each other to form a conductive line, the three scanning lines of the pixels connect with each other to form a conductive line;
each switch corresponds to one channel of the scanning drivers and corresponds to at least one column of the pixels, each switches includes an input and at least three outputs, the input of the switch electrically connects with one channel of the scanning driver, each of the outputs of the switch electrically connect with the scanning lines respectively for selectively input the scanning signals from the channel to the sub-pixel electrodes of the column;
the number of the outputs of the switch is the same with the number of the scanning lines of the pixels; and
the data drivers electrically connect with the data lines so as to input data signals to each of the sub-pixel electrodes.

2. The liquid crystal display as claimed in claim 1, wherein:
the controlled switch is a first thin film transistor;
each pixels includes a first scanning line, a second scanning line, a third scanning line arranged in the row direction, a gate of the first thin film transistors corresponding to the R sub-pixel electrode electrically connects with the first scanning line, the gate of the first thin film transistors corresponding to the R sub-pixel electrode electrically connects with the second scanning line, the gate of the first thin film transistors corresponding to the R sub-pixel electrode electrically connects with the second scanning line;
each switch corresponds to one column of pixels, each switch includes a first output, a second output and a third output electrically connects with the first scanning line, the second scanning line, the third scanning line respectively so as to selectively input the scanning signals from the scanning driver to sub-pixel electrodes of one column; and
wherein the switch inputs the scanning signals to the R sub-pixel electrode of the pixel of one column, and the data drivers inputs the data signals to the R sub-pixel electrode of the pixel of one column, the switch inputs the scanning signals to the G sub-pixel electrode of the pixel of one column, and the data drivers inputs the data signals to the G sub-pixel electrode of the pixel of one column, the switch inputs the scanning signals to the B sub-pixel electrode of the pixel of one column, and the data drivers inputs the data signals to the B sub-pixel electrode of the pixel of one column.

3. The liquid crystal display as claimed in claim 2, wherein each switches comprises:
a first selection line, a second selection line, a third selection line, a fourth selection line, a fifth selection line, a sixth selection line, a low level signal line arranged in the row direction;
a first driver for inputting level selection signals to the first selection line, the second selection line, the third selection line, the fourth selection line, the fifth selection line, the sixth selection line and for inputting inputs low level to the low level signal line;
a first field effect transistor, the gate of the first field effect transistor electrically connects with the first selection line, a source of the first field effect transistor electrically connects with one channel of the scanning driver, and a drain of the first field effect transistor electrically connects with the first scanning line;
a second field effect transistor, a gate of the second field effect transistor electrically connects with the second selection line, a source of the second field effect transistor electrically connects with one channel of the scanning driver, a drain of the second field effect transistor electrically connects with the second scanning line;
a third field effect transistor, a gate of the third field effect transistor electrically connects with the third selection line, a source of the third field effect transistor electrically connects with one channel of the scanning driver, and a drain of the third field effect transistor electrically connects with the third scanning line;
a fourth field effect transistor, a gate of the fourth field effect transistor electrically connects with the fourth selection line, a source of the fourth field effect transistor electrically connects with the low level signals lines, a drain of the fourth field effect transistor electrically connects with the first scanning line;
a fifth field effect transistor, a gate of the fifth field effect transistor electrically connects with the fifth selection line, a source of the fifth field effect transistor electrically connects with the low level signal line, a drain of the fifth field effect transistor electrically connects with the second scanning line;
a sixth field effect transistor, a gate of the sixth field effect transistor electrically connects with the sixth selection line, a source of the sixth field effect transistor electrically connects with the low level signal line, a drain of the sixth field effect transistor electrically connects with the third scanning line;
when the first driver inputs high level to the first selection line, the fifth selection line and the sixth selection line, the first field effect transistor, the fifth field effect transistor, and the sixth field effect transistor are closed, and when the first driver inputs low level to the second selection line, the third selection line, the fourth selection line and the low level signal line, the second field effect transistor, the third field effect transistor and the fourth field effect transistor are open, the scanning signals from the scanning driver are transmitted to the first scanning line via the first field effect transistor, the low level from the low level signal line is transmitted to the second scanning line via the fifth field effect transistor and is transmitted to the third scanning line via the sixth field effect transistor so as to input the scanning signals to the R sub-pixel electrodes;
when the first driver inputs high level to the second selection line, the fourth selection line and the sixth selection line, the second field effect transistor, the fourth field effect transistor and the sixth field effect transistor are closed, and when the first driver inputs the low level to the first selection line, the third selection line and the fifth selection line, the low level signal line, the first field effect transistor, the third field effect transistor and the fifth field effect transistor are open, the scanning signals from the scanning driver are transmitted to the second scanning line via the second field effect transistor, the low level from the low level signal line is transmitted to the first scanning line via the fourth field effect transistor and is transmitted to the third scanning line via the sixth field effect transistor so as to input the scanning signals to the G sub-pixel electrodes; and
when the first driver inputs the high level to the third selection line, the fourth selection line and the fifth selection line, the third field effect transistor, the fourth field effect transistor, and the fifth field effect transistor are closed, and when the first driver inputs the low level to the first selection line, the second selection line, the sixth selection line, and the low level signal line, the first field effect transistor, the second field effect transistor, and the sixth field effect transistor are open, the scanning signals from the scanning driver are transmitted to the third scanning line via the third field effect transistor, the low level from the low level signal line is transmitted to the first scanning line via the fourth field effect transistor and is transmitted to the second scanning line via the fifth field effect transistor so as to input the scanning signals to the B sub-pixel electrodes.

4. A liquid crystal display, comprising:
a first substrate;
a second substrate opposite to the first substrate;
a liquid crystal layer arranged between the first substrate and the second substrate, wherein the first substrate is an array substrate, and the second substrate is a color film substrate;
the first substrate comprises a plurality of pixels arranged in matrix, and a plurality of scanning drivers, a plurality of data drivers, a plurality of switches arranged in a rim of the matrix;
wherein each pixels comprises data lines arranged in a row direction, at least three scanning line arranged in a column direction, pixel electrodes and a plurality of controlled switches, each pixel electrodes comprises at least a R pixel electrode, a G pixel electrode, and a B pixel electrode arranged along the data line, and each of the R pixel electrode, the G pixel electrode, and the B pixel electrode at least corresponds to one scanning line and one controlled switch, controlled terminals of the controlled switches electrically connect with at least one scanning line, inputs of the controlled switches electrically connect with the data lines, outputs of the controlled switches electrically connect with the at least one of R sub-pixel electrodes, G sub-pixel electrodes, and B sub-pixel electrodes;
each switch corresponds to one channel of the scanning drivers and corresponds to at least one column of the pixels, each switches includes an input and at least three outputs, the input of the switch electrically connects with one channel of the scanning driver, each of the outputs of the switch electrically connect with the scanning lines respectively for selectively input the scanning signals from the channel to the sub-pixel electrodes of the column; and
the data drivers electrically connect with the data lines so as to input data signals to each of the sub-pixel electrodes.

5. The liquid crystal display as claimed in claim 4, wherein:
the controlled switch is a first thin film transistor;
each pixels includes a first scanning line, a second scanning line, a third scanning line arranged in the row direction, a gate of the first thin film transistors corresponding to the R sub-pixel electrode electrically connects with the first scanning line, the gate of the first thin film transistors corresponding to the R sub-pixel electrode electrically connects with the second scanning line, the gate of the first thin film transistors corresponding to the R sub-pixel electrode electrically connects with the second scanning line;
each switch corresponds to one column of pixels, each switch includes a first output, a second output and a third output electrically connects with the first scanning line, the second scanning line, the third scanning line respectively so as to selectively input the scanning signals from the scanning driver to sub-pixel electrodes of one column; and
wherein the switch inputs the scanning signals to the R sub-pixel electrode of the pixel of one column, and the data drivers inputs the data signals to the R sub-pixel electrode of the pixel of one column, the switch inputs the scanning signals to the G sub-pixel electrode of the pixel of one column, and the data drivers inputs the data signals to the G sub-pixel electrode of the pixel of one column, the switch inputs the scanning signals to the B sub-pixel electrode of the pixel of one column, and the data drivers inputs the data signals to the B sub-pixel electrode of the pixel of one column.

6. The liquid crystal display as claimed in claim 5, wherein each switches comprises:
a first selection line, a second selection line, a third selection line, a fourth selection line, a fifth selection line, a sixth selection line, a low level signal line arranged in the row direction;
a first driver for inputting level selection signals to the first selection line, the second selection line, the third selection line, the fourth selection line, the fifth selection line, the sixth selection line and for inputting inputs low level to the low level signal line;
a first field effect transistor, the gate of the first field effect transistor electrically connects with the first selection line, a source of the first field effect transistor electrically connects with one channel of the scanning driver, and a drain of the first field effect transistor electrically connects with the first scanning line;
a second field effect transistor, a gate of the second field effect transistor electrically connects with the second selection line, a source of the second field effect transistor electrically connects with one channel of the scanning driver, a drain of the second field effect transistor electrically connects with the second scanning line;
a third field effect transistor, a gate of the third field effect transistor electrically connects with the third selection line, a source of the third field effect transistor electrically connects with one channel of the scanning driver, and a drain of the third field effect transistor electrically connects with the third scanning line;
a fourth field effect transistor, a gate of the fourth field effect transistor electrically connects with the fourth selection line, a source of the fourth field effect transistor electrically connects with the low level signals lines, a drain of the fourth field effect transistor electrically connects with the first scanning line;
a fifth field effect transistor, a gate of the fifth field effect transistor electrically connects with the fifth selection line, a source of the fifth field effect transistor electrically connects with the low level signal line, a drain of the fifth field effect transistor electrically connects with the second scanning line;
a sixth field effect transistor, a gate of the sixth field effect transistor electrically connects with the sixth selection line, a source of the sixth field effect transistor electrically connects with the low level signal line, a drain of the sixth field effect transistor electrically connects with the third scanning line;
when the first driver inputs high level to the first selection line, the fifth selection line and the sixth selection line, the first field effect transistor, the fifth field effect transistor, and the sixth field effect transistor are closed, and when the first driver inputs low level to the second selection line, the third selection line, the fourth selection line and the low level signal line, the second field effect transistor, the third field effect transistor and the fourth field effect transistor are open, the scanning signals from the scanning driver are transmitted to the first scanning line via the first field effect transistor, the low level from the low level signal line is transmitted to the second scanning line via the fifth field effect transistor and is transmitted to the third scanning line via the sixth field effect transistor so as to input the scanning signals to the R sub-pixel electrodes;
when the first driver inputs high level to the second selection line, the fourth selection line and the sixth selection line, the second field effect transistor, the fourth field effect transistor and the sixth field effect transistor are closed, and when the first driver inputs the low level to the first selection line, the third selection line and the fifth selection line, the low level signal line, the first field effect transistor, the third field effect transistor and the fifth field effect transistor are open, the scanning signals from the scanning driver are transmitted to the second scanning line via the second field effect transistor, the low level from the low level signal line is transmitted to the first scanning line via the fourth field effect transistor and is transmitted to the third scanning line via the sixth field effect transistor so as to input the scanning signals to the G sub-pixel electrodes; and
when the first driver inputs the high level to the third selection line, the fourth selection line and the fifth selection line, the third field effect transistor, the fourth field effect transistor, and the fifth field effect transistor are closed, and when the first driver inputs the low level to the first selection line, the second selection line, the sixth selection line, and the low level signal line, the first field effect transistor, the second field effect transistor, and the sixth field effect transistor are open, the scanning signals from the scanning driver are transmitted to the third scanning line via the third field effect transistor, the low level from the low level signal line is transmitted to the first scanning line via the fourth field effect transistor and is transmitted to the second scanning line via the fifth field effect transistor so as to input the scanning signals to the B sub-pixel electrodes.

7. A liquid crystal display, comprising:
a plurality of scanning drivers, a plurality of data drivers, and a plurality of switches arranged in a rim of the matrix of pixels;
wherein each pixels comprises data lines arranged in a row direction, at least three scanning line arranged in a column direction, pixel electrodes and a plurality of controlled switches, each pixel electrodes comprises at least a R pixel electrode, a G pixel electrode, and a B pixel electrode arranged along the data line, and each of the R pixel electrode, the G pixel electrode, and the B pixel electrode at least corresponds to one scanning line and one controlled switch, controlled terminals of the controlled switches electrically connect with at least one scanning line, inputs of the controlled switches electrically connect with the data lines, outputs of the controlled switches electrically connect with the at least one of R sub-pixel electrodes, G sub-pixel electrodes, and B sub-pixel electrodes;
each switch corresponds to one channel of the scanning drivers and corresponds to at least one column of the pixels, each switches includes an input and at least three outputs, the input of the switch electrically connects with one channel of the scanning driver, each of the outputs of the switch electrically connect with the scanning lines respectively for selectively input the scanning signals from the channel to the sub-pixel electrodes of the column; and
the data drivers electrically connect with the data lines so as to input data signals to each of the sub-pixel electrodes.

8. The liquid crystal display as claimed in claim 7, wherein:
the controlled switch is a first thin film transistor;
each pixels includes a first scanning line, a second scanning line, a third scanning line arranged in the row direction, a gate of the first thin film transistors corresponding to the R sub-pixel electrode electrically connects with the first scanning line, the gate of the first thin film transistors corresponding to the R sub-pixel electrode electrically connects with the second scanning line, the gate of the first thin film transistors corresponding to the R sub-pixel electrode electrically connects with the second scanning line;
each switch corresponds to one column of pixels, each switch includes a first output, a second output and a third output electrically connects with the first scanning line, the second scanning line, the third scanning line respectively so as to selectively input the scanning signals from the scanning driver to sub-pixel electrodes of one column; and
wherein the switch inputs the scanning signals to the R sub-pixel electrode of the pixel of one column, and the data drivers inputs the data signals to the R sub-pixel electrode of the pixel of one column, the switch inputs the scanning signals to the G sub-pixel electrode of the pixel of one column, and the data drivers inputs the data signals to the G; sub-pixel electrode of the pixel of one column, the switch inputs the scanning signals to the B sub-pixel electrode of the pixel of one column, and the data drivers inputs the data signals to the B sub-pixel electrode of the pixel of one column.

9. The liquid crystal display as claimed in claim 8, wherein each switches comprises:
a first selection line, a second selection line, a third selection line, a fourth selection line, a fifth selection line, a sixth selection line, a low level signal line arranged in the row direction;
a first driver for inputting level selection signals to the first selection line, the second selection line, the third selection line, the fourth selection line, the fifth selection line, the sixth selection line and for inputting inputs low level to the low level signal line;
a first field effect transistor, the gate of the first field effect transistor electrically connects with the first selection line, a source of the first field effect transistor electrically connects with one channel of the scanning driver, and a drain of the first field effect transistor electrically connects with the first scanning line;
a second field effect transistor, a gate of the second field effect transistor electrically connects with the second selection line, a source of the second field effect transistor electrically connects with one channel of the scanning driver, a drain of the second field effect transistor electrically connects with the second scanning line;
a third field effect transistor, a gate of the third field effect transistor electrically connects with the third selection line, a source of the third field effect transistor electrically connects with one channel of the scanning driver, and a drain of the third field effect transistor electrically connects with the third scanning line;
a fourth field effect transistor, a gate of the fourth field effect transistor electrically connects with the fourth selection line, a source of the fourth field effect transistor electrically connects with the low level signals lines, a drain of the fourth field effect transistor electrically connects with the first scanning line;
a fifth field effect transistor, a gate of the fifth field effect transistor electrically connects with the fifth selection line, a source of the fifth field effect transistor electrically connects with the low level signal line, a drain of the fifth field effect transistor electrically connects with the second scanning line;
a sixth field effect transistor, a gate of the sixth field effect transistor electrically connects with the sixth selection line, a source of the sixth field effect transistor electrically connects with the low level signal line, a drain of the sixth field effect transistor electrically connects with the third scanning line;
when the first driver inputs high level to the first selection line, the fifth selection line and the sixth selection line, the first field effect transistor, the fifth field effect transistor, and the sixth field effect transistor are closed, and when the first driver inputs low level to the second selection line, the third selection line, the fourth selection line and the low level signal line, the second field effect transistor, the third field effect transistor and the fourth field effect transistor are open, the scanning signals from the scanning driver are transmitted to the first scanning line via the first field effect transistor, the low level from the low level signal line is transmitted to the second scanning line via the fifth field effect transistor and is transmitted to the third scanning line via the sixth field effect transistor so as to input the scanning signals to the R sub-pixel electrodes;
when the first driver inputs high level to the second selection line, the fourth selection line and the sixth selection line, the second field effect transistor, the fourth field effect transistor and the sixth field effect transistor are closed, and when the first driver inputs the low level to the first selection line, the third selection line and the fifth selection line, the low level signal line, the first field effect transistor, the third field effect transistor and the fifth field effect transistor are open, the scanning signals from the scanning driver are transmitted to the second scanning line via the second field effect transistor, the low level from the low level signal line is transmitted to the first scanning line via the fourth field effect transistor and is transmitted to the third scanning line via the sixth field effect transistor so as to input the scanning signals to the G sub-pixel electrodes; and
when the first driver inputs the high level to the third selection line, the fourth selection line and the fifth selection line, the third field effect transistor, the fourth field effect transistor, and the fifth field effect transistor are closed, and when the first driver inputs the low level to the first selection line, the second selection line, the sixth selection line, and the low level signal line, the first field effect transistor, the second field effect transistor, and the sixth field effect transistor are open, the scanning signals from the scanning driver are transmitted to the third scanning line via the third field effect transistor, the low level from the low level signal line is transmitted to the first scanning line via the fourth field effect transistor and is transmitted to the second scanning line via the fifth field effect transistor so as to input the scanning signals to the B sub-pixel electrodes.
